(19) United States
(12) Patent Application Publication
(10) Pub. No.: US 2011/0093921 A1
(43) Pub. Date: Apr. 21, 2011

(54) MULTI-FUNCTIONAL PERIPHERAL AND MULTI-FUNCTIONAL PERIPHERAL CONTROL SYSTEM

(75) Inventor: Kunihiko Tsujimoto, Osaka (JP)

(73) Assignee: SHARP KABUSHIKI KAISHA, Osaka (JP)

(21) Appl. No.: 12/905,488

(22) Filed: Oct. 15, 2010

(30) Foreign Application Priority Data
Oct. 15, 2009 (JP) 2009-238347

(51) Int. Cl. G06F 21/00

(52) U.S. Cl. 726/3

(57) ABSTRACT

This invention provides a multi-functional peripheral and a multi-functional peripheral control system that manage a total number of output sheets of a user strictly and accurately even when an authentication server of a multi-functional peripheral is not able to perform authentication due to network failure or the like and authentication and output limitation are performed in the multi-functional peripheral. When the number of outputtable sheets registered in a user information management table is not 0, the multi-functional peripheral executes a copy job. When the number of copy outputtable sheets becomes 0, or when copy output of all pages is completed, the number of output sheets is deducted from the number of copy outputtable sheets registered in the user information management table, and thereby the user information management table is updated. Then, when connection to the authentication server is restored, the authentication server updates a user information management DB.

### CROSS-NOTING PARAGRAPH

This non-provisional application claims priority under 35 U.S.C. §119(a) on Patent Application No. 2009-238347 filed in JAPAN on Oct. 15, 2009, the entire contents of which are hereby incorporated herein by reference.

### FIELD OF THE INVENTION

The present invention relates to a multi-functional peripheral control system in which a multi-functional peripheral including multiple functions and an authentication server that performs authentication processing as well as limitation of the number of output sheets are connected to a network, and a multi-functional peripheral of the multi-functional peripheral control system.

### BACKGROUND OF THE INVENTION

Generally, in an environment in which a user selects any one from among a plurality of image forming apparatuses to be able to perform copying, printing, facsimile transmission, or the like, in the case of performing authentication, authorization restriction, limitation of the number of output sheets, charge management and the like for each user, a plurality of image forming apparatuses and an authentication server are connected to a network so that the above-described management is performed uniformly in the authentication server.

However, in the case where authentication is not able to be performed due to a crash of an authentication server, network failure or the like, a user is not able to use an image forming apparatus.

Therefore, in an authentication system of Japanese Laid-Open Patent Publication No. 2006-92018, second authentication means is included in an image forming apparatus, and when an authentication server is not able to perform authentication due to network failure or the like, authentication and limitation of the number of output sheets are performed in the second authentication means so that the image forming apparatus is available within a range of the limitation of the number of output sheets.

Incidentally, the number of sheets less than the number of outputtable sheets (limitation of the number of output sheets) in first authentication means of the authentication server is applied to limitation of the number of output sheets in the second authentication means of the image forming apparatus that is disclosed in Japanese Laid-Open Patent Publication No. 2006-92018. For example, according to authentication in the first authentication means of an authentication server, for a user X, even when the number of outputtable sheets is 20 sheets at a time (one copy job execution), using the second authentication means of the image forming apparatus results in 10 sheets at a time.

Further, the second authentication means of the image forming apparatus that is disclosed in Japanese Laid-Open Patent Publication No. 2006-92018 only limits the number of sheets that is able to be output at a time but is not able to limit (manage) a total number of output sheets. For example, when the number of outputtable sheets of the user X is limited to 20 sheets at a time, printing of 10 sheets at a time can be performed three times (the total number of output sheets is 30 sheets) in the authentication system of Japanese Laid-Open Patent Publication No. 2006-92018.

In this way, according to the authentication system that is disclosed in Japanese Laid-Open Patent Publication No. 2006-92018, when the authentication server of an image forming apparatus is not able to perform authentication due to network failure or the like, and authentication and output limitation are performed in the image forming apparatus, it is impossible to manage the total number of output sheets of a user strictly and accurately.

### SUMMARY OF THE INVENTION

An object of the present invention is to provide a multi-functional peripheral and a multi-functional peripheral control system that manage a total number of output sheets of a user strictly and accurately even when an authentication server of the multi-functional peripheral is not able to perform authentication due to network failure or the like and authentication and output limitation are performed in the multi-functional peripheral.

Another object of the present invention is to provide a multi-functional peripheral of one or more multi-functional peripherals provided in a multi-functional peripheral control system, the multi-functional peripheral control system comprising an authentication server which has a user information management database for storing authentication information of each user and the number of outputtable sheets for each user, performs user authentication processing with reference to the user information management database, and manages the one or more multi-functional peripherals, the multi-functional peripheral comprising: a storage portion that stores a user information management table that registers authentication information of each user and the number of outputtable sheets for each user; a user confirmation portion that, when the authentication server is available, transmits user information to the authentication server so that the authentication server performs authentication processing using the user information, and, when the authentication server is not available, performs alternate authentication by referring to the user information management table; a job execution portion that executes, when execution of a job in which the number of outputtable sheets is updated is instructed, the job in the case where the number of outputtable sheets concerning the job is not 0; and a table updating portion that updates the user information management table based on data acquired from the user information management database of the authentication server when the authentication server is available and the user information is transmitted by the user confirmation portion and a job is executed by the job execution portion, and updates the user information management table by deducting the number of output sheets output by the job from the number of outputtable sheets that is registered in the user information management table when the authentication server is not available and the alternate authentication is performed by the user confirmation portion and the job is executed by the job execution portion.

Another object of the present invention is to provide the multi-functional peripheral wherein the job execution portion, when the authentication server becomes available, transmits to the authentication server the number of outputtable sheets registered in the user information management table updated by the table updating portion to update the number of outputtable sheets stored by the user information management database of the authentication server.

Another object of the present invention is to provide a multi-functional peripheral control system comprising an authentication server that has a user information management database for storing authentication information of each user and the number of outputtable sheets for each user and performs user authentication processing with reference to the user information management database, and one or more multi-functional peripherals managed by the authentication server, wherein the multi-functional peripheral comprises: a storage portion that stores a user information management table that registers authentication information of each user and the number of outputtable sheets for each user; a user confirmation portion that, when the authentication server is available, transmits user information to the authentication server so that the authentication server performs authentication processing using the user information, and, when the authentication server is not available, performs alternate authentication by referring to the user information management table; a job execution portion that executes, when execution of a job in which the number of outputtable sheets is updated is instructed, the job in the case where the number of outputtable sheets concerning the job is not 0; and a table updating portion that updates the user information management table based on data acquired from the user information management database of the authentication server when the authentication server is available and the user information is transmitted by the user confirmation portion and a job is executed by the job execution portion, and updates the user information management table by deducting the number of output sheets output by the job from the number of outputtable sheets that is registered in the user information management table when the authentication server is not available and the alternate authentication is performed by the user confirmation portion and the job is executed by the job execution portion.

Another object of the present invention is to provide the multi-functional peripheral control system wherein the job execution portion of the multi-functional peripheral, when the authentication server becomes available, transmits to the authentication server the number of outputtable sheets registered in the user information management table updated by the table updating portion, and the authentication server comprises an authentication portion that receives the number of outputtable sheets registered in the user information management table that is transmitted from the job execution portion to update the number of outputtable sheets stored in the user information management database of the authentication server to correspond to the number of outputtable sheets that registered in the user information management table.

### BRIEF DESCRIPTION OF THE DRAWINGS

FIG. 1 is a block diagram showing a schematic configuration of a multi-functional peripheral control system according to an embodiment of the present invention;

FIG. 2A is an example of a user information management table of the multi-functional peripheral;

FIG. 2B is an example of a data structure of a user information management database of an authentication server;

FIG. 3A is a flowchart showing a processing procedure that is executed in the multi-functional peripheral control system of the present invention; and

FIG. 3B is a flowchart showing a processing procedure that is executed in the multi-functional peripheral control system of the present invention.

### PREFERRED EMBODIMENTS OF THE INVENTION

### Schematic Configuration of Multi-Functional Peripheral Control System

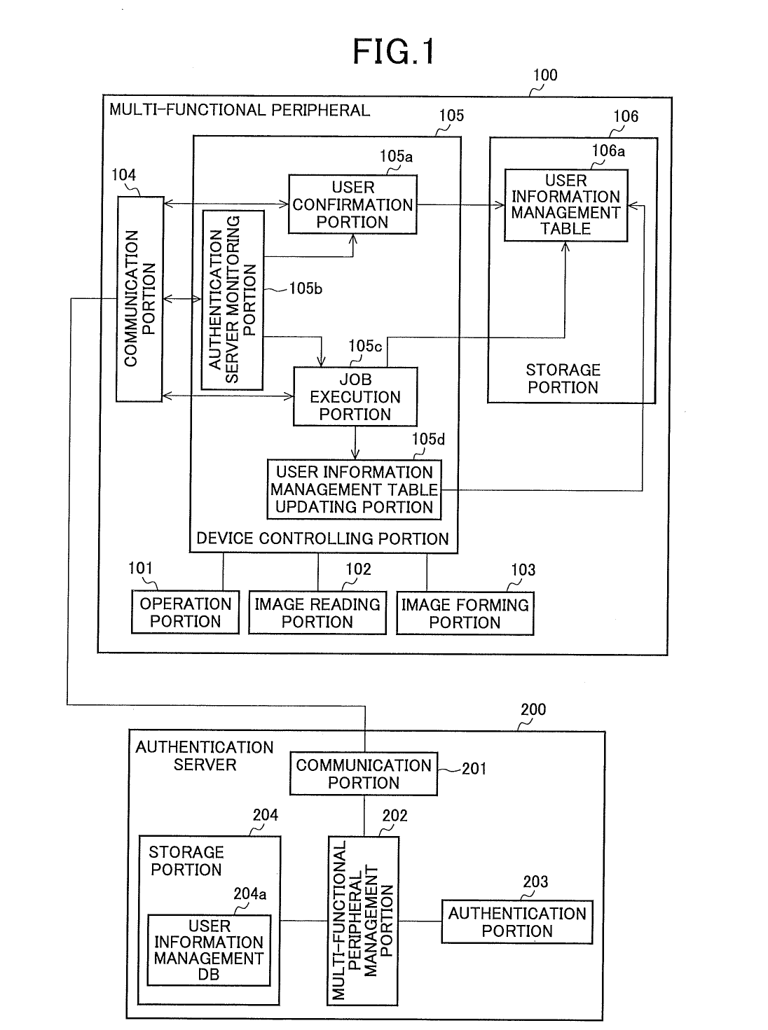

FIG. 1 is a block diagram showing a schematic configuration of a multi-functional peripheral control system according to an embodiment of the present invention. In the diagram, the multi-functional peripheral control system, for example, is configured so that one or more multi-functional peripherals 100 in which a plurality of functions such as a copy function, a scanner function, a facsimile function and a printer function are available is connected through a network to an authentication server 200 that performs authentication processing of a job that is executed at a multi-functional peripheral 100 (user authentication, authorization restriction management and management of limitation of the number of output sheets) and manages the multi-functional peripheral 100.

<Configuration of Multi-Functional Peripheral>

In FIG. 1, the multi-functional peripheral 100 includes an operation portion 101, an image reading portion 102, an image forming portion 103, a communication portion 104, a device controlling portion 105 and a storage portion 106, and is controlled by the device controlling portion 105.

The operation portion 101 is composed of a plurality of operation keys for receiving operation input of a user, an LCD (Liquid Crystal Display) integrated with a touch panel and the like, and a login screen, a job deletion message and the like in the present embodiment are displayed on the LCD.

The image reading portion 102 irradiates a document with an image irradiation lamp and a reflected light therefrom is received by a CCD (Charge Coupled Device) sensor so that an image is read from the document and image data corresponding to the read image is output.

The image forming portion 103 prints on a sheet the image data read at the image reading portion 102, image data that is transmitted from a client PC (personal computer) or the like through a LAN (Local Area Network) via the communication portion 104 and image data received from a facsimile apparatus or the like.

The communication portion 104 controls transmission/reception of various data to/from the authentication server 200, a client PC, a facsimile apparatus and the like that are connected through a LAN with use of a network interface or the like.

The device controlling portion 105 includes a CPU (Central Processing Unit), a RAM (Random Access Memory), a ROM (Read Only Memory) and the like, and reads various control programs and setting information from the storage portion 106 to realize functions provided in the multi-functional peripheral 100.

The device controlling portion 105 of the present embodiment includes a user confirmation portion 105a that executes various confirmation processing according to user authentication, an authentication server monitoring portion 105b that monitors whether the authentication server 200 is available or not, a job execution portion 105c that controls various processing concerning execution of a job and a user information management table updating portion (table updating means) 105d that executes updating processing of a user information management table (described below).

The storage portion 106 stores various control programs of the multi-functional peripheral 100, fixed information that is used for various control programs, setting information set by a user at the time of use of the multi-functional peripheral 100, state information in an execution state of the multi-functional peripheral 100 or the like. Additionally, the storage portion 106 is also used for storing the user information management table 106a that is used for authentication by the multi-functional peripheral 100 itself, and image data that is subjected to image processing by the image reading portion 102 and the image forming portion 103.

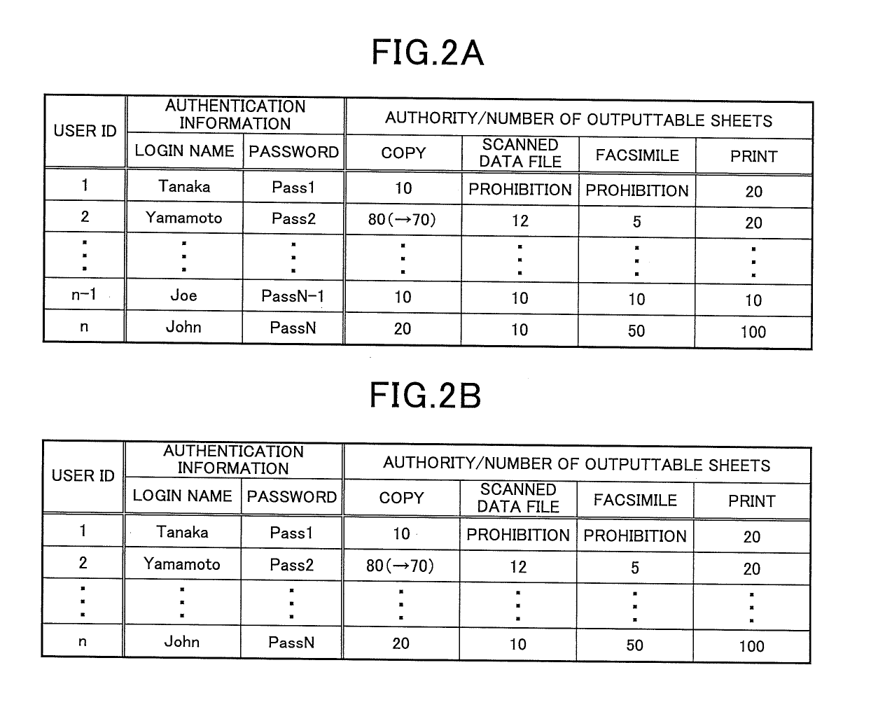

FIG. 2A is an example of the user information management table 106a in the multi-functional peripheral 100. The user information management table 106a is created based on data received from the authentication server 200 as described below.

The user information management table 106a includes data items for each user as illustrated in FIG. 2A, and is composed of a user ID, authentication information (login name, password), and authority restriction information and information of the number of outputtable sheets for each job type. That is, authentication information, the number of outputtable sheets and the like are stored corresponding to each user. The user information management table 106a is used when the multi-functional peripheral 100 itself performs user authentication when the authentication server 200 is not available due to network failure or the like.

User ID: An identifier (ID) for identifying a user in a multi-functional peripheral is stored.

Login name: A login name for authenticating a user is stored.

Password: A password for authenticating a user is stored.

Authority and the number of outputtable sheets (total number of outputtable sheets): For each function provided in a multi-functional peripheral, authority that a user has and the number of outputtable sheets are stored. In the case of having no authority for using a function, “prohibition” is stored for the function, and in the case of having authority for using, a total number of outputtable sheets that is allowed to output by the authority is stored. “0” may be stored, replacing the “prohibition”. Note that, “copy” indicates the number of printed sheets that is output by copying a document. “Scanned data file” indicated the number of scanned data files created by scanning a document. For example, when 5 sheets of a document are scanned, 5 scanned date files are created. “Facsimile” indicates the number of sheets of a transmitted document, and “print” indicates the number of printed sheets that is output by execution of a print job (printing).

<Configuration of Authentication Server>

The authentication server 200 of FIG. 1 includes a communication portion 201, a multi-functional peripheral management portion 202, an authentication portion 203 and a storage portion 204, and is controlled by the multi-functional peripheral management portion 202.

The communication portion 201 controls transmission/reception of various data to/from one or more multi-functional peripherals 100, PCs and the like that are connected via a LAN with use of a network interface or the like.

The multi-functional peripheral management portion 202 includes a CPU, a RAM, a ROM and the like, and reads various control programs and setting information from the storage portion 204 to realize functions provided in the authentication server 200.

The authentication portion 203 refers to a user information management DB (database) 204a to determine whether or not a user whose authentication is requested from the multi-functional peripheral 100 may use the multi-functional peripheral 100.

The storage portion 204 stores various control programs of the authentication server 200, fixed information that is used in various control programs, or information in an execution state of the authentication server 200. Further, the storage portion 204 includes a user information management DB 204a for performing user authentication from each multi-functional peripheral 100 connected to a network. Note that, a login screen DB for storing a screen (data) for user login that is displayed at the multi-functional peripheral 100 in user authentication may be included in the storage portion 204.

FIG. 2B is an example of a data structure of the user information management DB 204a in the authentication server 200. The user information management DB 204a includes data items for each user as illustrated in FIG. 2B, and stores a user ID, authentication information (login name, password) authority restriction information and information of the number of outputtable sheets for each job type similarly to the user information management table 106a. That is, authentication information and the number of outputtable sheets are stored corresponding to each user.

The authentication server 200 performs user authentication processing referring to the user information management DB 204a.

Hereinafter, description will be given for details of various sorts of processing that are executed in a multi-functional peripheral control system of the present invention.

First, description will be given for a case where user authentication is executed in the authentication server 200 in the state where the multi-functional peripheral 100 is connected to the authentication server 200.

The authentication server monitoring portion 105b of the multi-functional peripheral 100 monitors whether the authentication server 200 that manages the multi-functional peripheral 100 is available or not at a predetermined time interval, transmits a “pause signal” to the user confirmation portion 105a when the authentication server 200 is not available, and transmits a “connection signal” when the authentication server 200 is available.

Moreover, the “connection signal” is transmitted to the user confirmation portion 105a when restoring the state that the authentication server 200 is available.

The user confirmation portion 105a performs authentication processing (also referred to as external authentication) at the authentication server 200 while receiving a “connection signal” from the authentication server monitoring portion 105b.

At the time, a user authentication request including a login name and a password that are input is transmitted to the authentication server 200. The multi-functional peripheral management portion 202 of the authentication server 200 receives the user authentication request from the multi-functional peripheral 100 via the communication portion 201, and user authentication is executed by the authentication portion 203. For the user authentication request, a login name and a password of a user are designated.

When the login name and the password designated in the user authentication request are stored in the user information management DB 204a having one to one correspondence with each other, the authentication portion 203 returns authentication information and authority/the number of outputtable sheets of the user in the user information management DB 204a together with “authentication permission”. When the storage has not been made, “refusal of authentication permission” is returned.

When “refusal of authentication permission” is returned from the authentication server 200, a message such that authentication has not been successfully performed is displayed on the operation portion 101 to urge to login again.

On the other hand, when “authentication permission”, authentication information and authority/the number of outputtable sheets of the user are returned from the authentication server 200, the job execution portion 105c and the user information management table updating portion 105d are started to operate.

For example, a user Yamamoto (hereinafter, indicated as a user Y) shown in FIG. 2A and FIG. 2B performs input (login) of a login name: Yamamoto and a password: Pass2, via a screen for user login including a login name input box and a password input box displayed on the operation portion 101 of the multi-functional peripheral 100. Then, “authentication permission”, authentication information of a user Y (in examples of FIG. 2A and FIG. 2B, login name: Yamamoto, password: Pass2) and authority/the number of outputtable sheets (in examples of FIG. 2A and FIG. 2B, copy: 80, scan: 12, facsimile: 5, print: 20) are returned from the authentication server 200.

The user information management table updating portion 105d of the multi-functional peripheral 100 that receives “authentication permission”, authentication information and authority/the number of outputtable sheets of the user from the authentication server 200 updates (stores) authentication information and authority/the number of outputtable sheets of the user Yin the user information management table 106a. That is, the multi-functional peripheral 100 transmits user information to the authentication server 200 to perform authentication processing and processing for limitation of the number of output sheets when the authentication server 200 is available, and updates the user information management table 106a based on data acquired from the user information management DB 204a of the authentication server 200.

Next, when the user Y instructs execution of a job in which the number of outputtable sheets is updated, for example, a copy job, via the operation portion 101, the job execution portion 105c inquires of the authentication portion 203 of the authentication server 200 whether or not the number of copy outputtable sheets of the user Y is 0 or “prohibition”. Since the number of copy outputtable sheets is 80 sheets for the user Y, the authentication portion 203 returns “execution permission” to the multi-functional peripheral 100. In the case where the number of copy outputtable sheets is 0 or “prohibition”, the authentication portion 203 returns “refusal of execution permission” to the multi-functional peripheral 100. Note that, the job execution portion 105c of the multi-functional peripheral 100 may detect (determine) whether or not the number of copy outputtable sheets of the user Y in the user information management table 106a is 0 or “prohibition”.

When “execution permission” is returned from the authentication server 200, that is, when the number of copy outputtable sheets of the user Y is not 0 or “prohibition”, the job execution portion 105c instructs the image forming portion 103 or the like to execute a copy job instructed by the user Y and executes the copy job. At the same time, the job execution portion 105c counts the number of output sheets to be copied by the execution of copy job. After execution of the copy job, the user information management table updating portion 105d updates the user information management table 106a by deducting the counted number of output sheets from the number of copy outputtable sheets (80 sheets) of the user information management table 106a. When the number of copy output sheets is 10 sheets, the number of copy outputtable sheets stored by the user Y: 80 sheets is updated to 70 sheets.

Further, the job execution portion 105c transmits the counted number of copy output sheets to the authentication portion 203 of the authentication server 200, and the authentication portion 203 updates the user information management DB 204a by deducting the number of copy output sheets from the number of copy outputtable sheets stored by the user information management DB 204a (80 sheets).

When “refusal of execution permission” is returned from the authentication server 200, the job execution portion 105c does not execute a copy job instructed by the user Y but gives the notice of that effect to the user Y.

Note that, when the number of outputtable sheets becomes 0 during the execution of a copy job, the job is stopped at that point, and the user information management table 106a and the user information management DB 204a are updated as described above. At the time, a user is notified that the number of outputtable sheets is 0.

Next, description will be given for a case where user authentication is executed in the multi-functional peripheral 100 itself in a state where the multi-functional peripheral 100 is not connected to the authentication server 200.

While the user confirmation portion 105a receives the “pause signal”, the multi-functional peripheral 100 itself refers to the user information management table 106a, and authentication processing (also referred to as alternate authentication) is performed in the same procedure as that of the above-described external authentication. Note that, it is assumed that the multi-functional peripheral 100 is connected to the authentication server 200 to receive in advance authentication information and authority/the number of outputtable sheets of the user, and each information is stored in the user information management table 106a.

In the case where the above-described user Y logs in, when the login name: Yamamoto, and the password: Pass2 are input, the user confirmation portion 105a of the multi-functional peripheral 100 permits authentication.

Then, as described above, when the user Y instructs the job execution portion 105c, for example, to execute a copy job via the operation portion 101, the job execution portion 105c detects whether or not the number of copy outputtable sheets of the user Y of the user information management table 106a is 0 or “prohibition”.

When the number of copy outputtable sheets of the user Y is not 0 or “prohibition”, as described above, the job execution portion 105c instructs the image forming portion 103 or the like to execute a copy job instructed by the user Y, and executes the copy job. At the same time, the number of output sheets to be copied by the execution of copy job is counted. After the execution of copy job, the user information management table updating portion 105d deducts the counted number of output sheets from the number of copy outputtable sheets (80 sheets) of the user information management table 106a to update the user information management table 106a. In the above-described example, the number of copy outputtable sheets of the user Y: 80 sheets is updated to 70 sheets.

Note that, when the number of copy outputtable sheets is 0 or “prohibition”, the copy job is not executed.

Thereafter, when the multi-functional peripheral 100 becomes connectable to the authentication server 200, a changed content of the user information management table 106a of the multi-functional peripheral 100 is reflected in the user information management DB 204a of the authentication server 200.

In the above-described example, the device controlling portion 105 of the multi-functional peripheral 100 transmits the updated number of copy outputtable sheets (the number of copy outputtable sheets of the user Y: 70 sheets) to the authentication server 200. The multi-functional peripheral management portion 202 of the authentication server 200 that receives the updated number of copy outputtable sheets updates the user information management DB 204a based on the received updated number of outputtable sheets. Here, the number of copy outputtable sheets of the user Y: 80 sheets is updated to 70 sheets.

That is, the multi-functional peripheral 100, when the authentication server 200 is not available, refers to the user information management table 106a of the multi-functional peripheral 100 to perform alternate authentication in the multi-functional peripheral 100, and when execution of a job such as a copy job is instructed, in the case where the number of outputtable sheets concerning the job is not 0, executes the job and updates the user information management table 106a by deducting the number of output sheets by the execution of the job from the number of outputtable sheets stored in the user information management table 106a. Thereafter, the multi-functional peripheral 100, when the authentication server 200 becomes available, transmits the number of outputtable sheets registered in the user information management table 106a updated by the user information management table updating portion 105d to the authentication server 200 in order to update the number of outputtable sheets stored by the user information management DB 204a of the authentication server 200. Then, the authentication server 200 receives the number of outputtable sheets registered in the user information management table 106a to be transmitted from the multi-functional peripheral 100 to update the number of outputtable sheets stored in the user information management DB 204a to correspond to the number of outputtable sheets registered in the user information management table 106a.

In this way, even when the authentication server 200 of the multi-functional peripheral 100 is not able to perform authentication due to network failure or the like and the multi-functional peripheral 100 performs authentication and output limitation, the multi-functional peripheral 100 performs output limitation of the user based on management information of the user downloaded in advance from the authentication server 200, and therefore is able to manage the total number of output sheets of the user strictly and accurately. Additionally, the user information management table 106a of the multi-functional peripheral 100 is updated at any time, and when connection between the multi-functional peripheral 100 and the authentication server 200 is restored, the content of the user information management table 106a of the multi-functional peripheral 100 is reflected in the user information management DB 204a of the authentication server 200, and therefore, it is possible to manage the total number of output sheets of the user accurately after that.

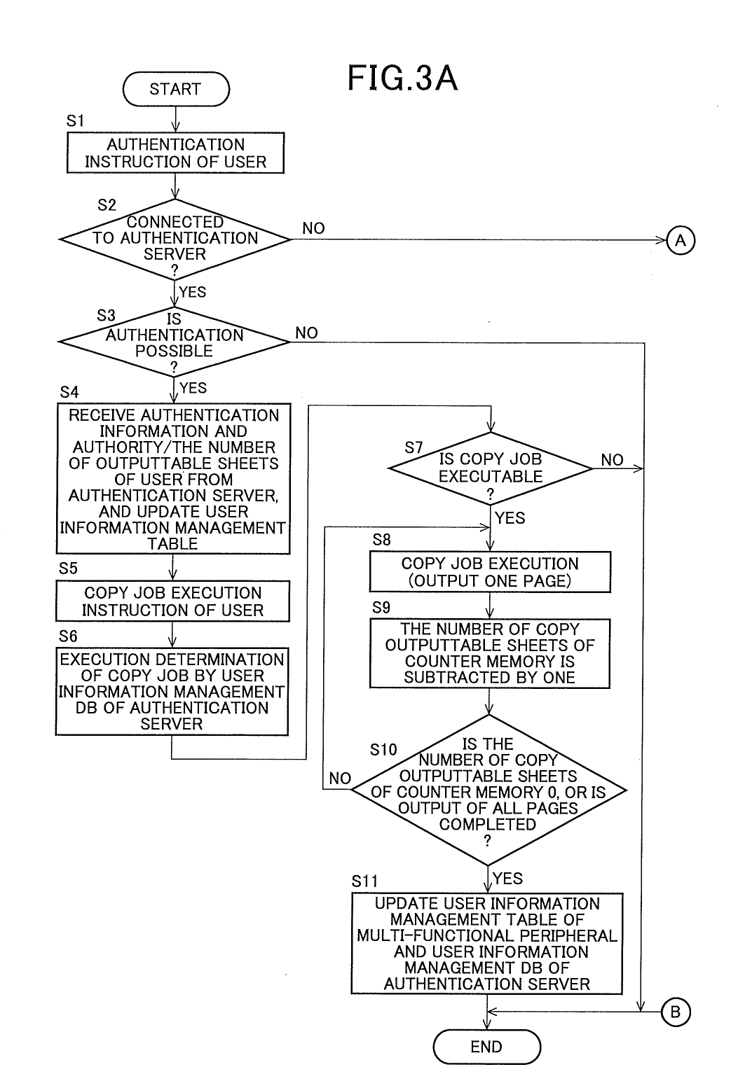

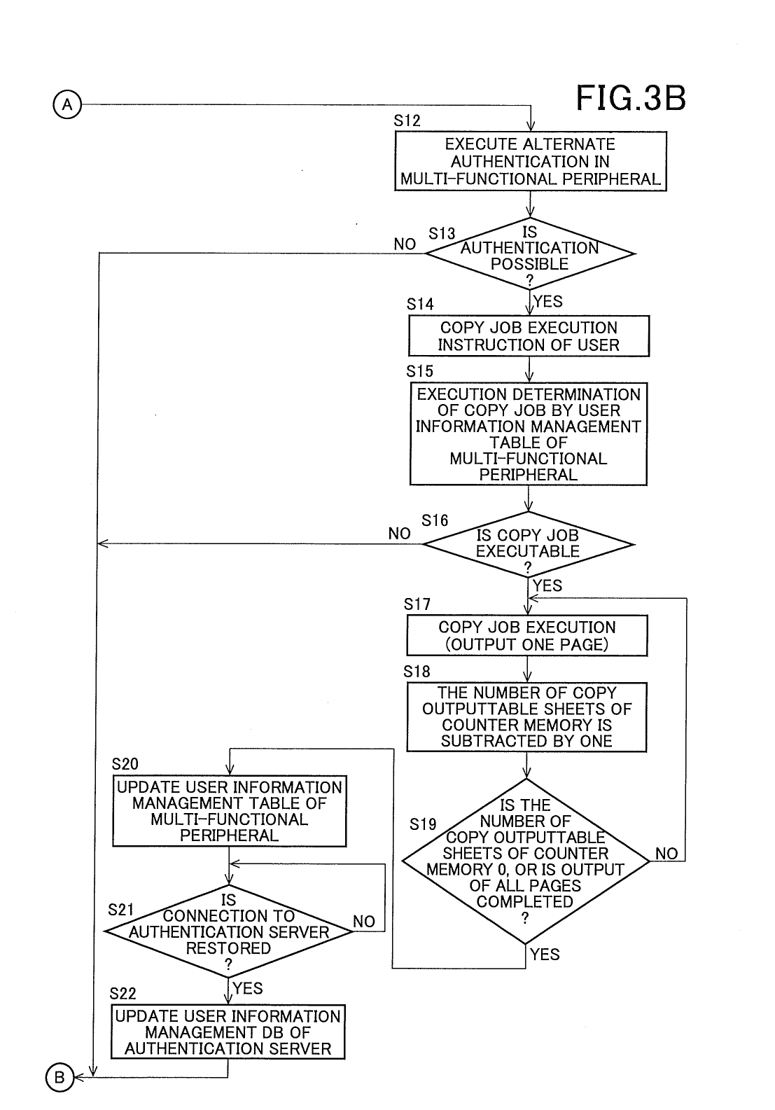

Next, description will be given for the above-described processing using flowcharts of FIG. 3A and FIG. 3B. Note that, it is assumed that the multi-functional peripheral 100 is connected to the authentication server 200 to receive in advance authentication information and authority/the number of outputtable sheets of the user, and each information is stored in the user information management table 106a.

First, a user inputs a login name and a password in the multi-functional peripheral 100 and gives an authentication instruction to the multi-functional peripheral 100 (step S1). Then, the authentication server monitoring portion 105b of the multi-functional peripheral 100 detects whether the authentication server 200 is available or not (step S2).

When the authentication server 200 is available (step S2/YES), the authentication portion 203 of the authentication server 200 determines whether or not the user is authenticated (step S3).

In the case of authenticating the user (step S3/YES), the authentication server 200 transmits “authentication permission”, authentication information and authority/the number of outputtable sheets information of the user to the multi-functional peripheral 100, and the user information management table updating portion 105d of the multi-functional peripheral 100 that received the information updates authentication information and the authority/the number of outputtable sheets of the user in the user information management table 106a (step S4).

Next, when the user instructs the multi-functional peripheral 100 to execute a copy job (step S5), the authentication portion 203 of the authentication server 200 performs execution determination of the copy job (step S6). Specifically, the job execution portion 105c of the multi-functional peripheral 100 inquires of the authentication portion 203 of the authentication server 200 whether or not the number of copy outputtable sheets of the user is 0 or “prohibition”.

When execution of the copy job is possible (step S7/YES), that is, when the number of copy outputtable sheets of the user is not 0 or “prohibition”, the job execution portion 105c stores the number of copy outputtable sheets of the user in the storage portion 106 (counter memory) and executes the copy job at step S8 (copy output of one page). At the same time, the job execution portion 105c counts the number of output sheets to be copied by the execution of copy job (counting up by one).

Next, at step S9, the number of copy outputtable sheets stored in the counter memory is subtracted by one.

When the number of copy outputtable sheets stored in the counter memory is 0, or copy output of all pages is completed (step S10/YES), the job execution portion 105c transmits the counted number of copy output sheets to the authentication portion 203 of the authentication server 200, and the authentication portion 203 updates the user information management DB 204a by deducting the number of copy output sheets from the number of copy outputtable sheets stored in the user information management DB 204a (step S11). Additionally, the user information management table updating portion 105d of the multi-functional peripheral 100 updates the user information management table 106a by deducting the counted number of output sheets from the number of copy outputtable sheets registered in the user information management table 106a.

When the number of copy outputtable sheets stored in the counter memory is not 0, and copy output of all pages is not completed (step S10/NO), the flow returns to the step S8.

At the step S2, when the multi-functional peripheral 100 is not connectable to the authentication server 200 (step S2/NO), the user confirmation portion 105a of the multi-functional peripheral 100 executes alternate authentication (step S12).

In the case of authenticating the user (step S13/YES), the user subsequently instructs the multi-functional peripheral 100 to execute the copy job (step S14). Then, the job execution portion 105c of the multi-functional peripheral 100 performs execution determination of the copy job (step S15). Specifically, the job execution portion 105c of the multi-functional peripheral 100 determines whether or not the number of copy outputtable sheets registered in the user of the user information management table 106a is 0 or “prohibition”.

When execution of the copy job is possible (step S16/YES), that is, when the number of copy outputtable sheets of the user is not 0 or “prohibition”, the job execution portion 105c of the multi-functional peripheral 100 stores the number of copy outputtable sheets of the user in the counter memory and executes the copy job at step S17 (copy output of one page). At the same time, the job execution portion 105c counts the number of output sheets to be copied by the execution of copy job (counting up by one).

Next, at step S18, 1 is subtracted from the number of copy outputtable sheets stored in the counter memory.

When the number of copy outputtable sheets stored in the counter memory is 0, or copy output of all pages is completed (step S19/YES), the user information management table updating portion 105d updates the user information management table 106a by deducting the counted number of output sheets from the number of copy outputtable sheets registered in the user information management table 106a (step S20).

When the number of copy outputtable sheets stored in the counter memory is not 0, and copy output of all pages is not completed (step S19/NO), the flow returns to the step S17.

Thereafter, when connection to the authentication server 200 is restored (step S21/YES), the job execution portion 105c transmits a counted number of copy output sheets to the authentication portion 203 of the authentication server 200, and the authentication portion 203 updates the user information management DB 204a by deducting the counted number of copy output sheets from the number of copy outputtable sheets stored in the user information management DB 204a (step S22).

Note that, in the case of not authenticating the user (step S3 or step S13/NO) or in the case of not being able to execute the copy job (step S7 or step S16/NO), the notification is given to the user and processing is finished.

According to the present invention, even when authentication and output limitation are performed in the multi-functional peripheral 100 connected to the authentication server 200, it is possible to manage the total number of output sheets of the user strictly and accurately.

(Others)

In the state where the multi-functional peripheral 100 is connected to the authentication server 200, screen data for user login is acquired from the authentication server 200 to be stored, then in the state where the multi-functional peripheral 100 is not connectable to the authentication server 200 (alternate authentication), the acquired screen data for user login may be displayed. When the user inputs authentication information (for example, login name and password) via the screen data for user login displayed in the multi-functional peripheral 100, the multi-functional peripheral 100 refers to an authentication information column of the user information management table 106a of the multi-functional peripheral 100 to execute user authentication. Note that, in order to execute the user authentication, for example, “item identification name: id_username” and “item identification name: id_password” for identifying input (box) of the login name and the password may be included in the screen data for user login, and “item identification name: id_username” and “item identification name: id_password” may be included in a login name column and a password column of the authentication information column of the user information management table 106a corresponding thereto, respectively.

In this way, the screen for user login displayed in the state that the authentication server 200 is available and the screen for user login displayed in the state that the authentication server 200 is not available (alternate authentication) may be brought into the same screens, and therefore the user is able to input login information without having a sense of discomfort.

In the case where the screen data for user login is not able to be acquired from the authentication server 200, or where the acquired screen data for user login is not able to be stored, screen data for user login may be dynamically created based on information stored in the authentication information column of the user information management table 106a. Since authentication information of the user information management table 106a shown in FIG. 2A includes a login name and a password, the multi-functional peripheral 100 creates and displays screen data for user login having an input box of a login name and a password.

Additionally, authentication information (items) included in the screen data for user login provided by the authentication server 200 is different for each authentication server 200 in some cases. For example, authentication information includes only user name/password in some cases, and user name/password/domain or user name/password/e-mail address in other cases, and login information in the authentication server 200 is variable.

Then, in order to correspond to authentication information that is different for each authentication server 200, the multi-functional peripheral 100 dynamically creates screen data for user login that is displayed at the time of alternate authentication in the multi-functional peripheral 100 based on the authentication information of the user information management table 106a of the multi-functional peripheral 100 correspondingly stored in the user information management DB 204a that is referred to at the time of user authentication in the authentication server 200.

In this way, it is possible to flexibly deal with various authentication systems.

According to the present invention, even when an authentication server of a multi-functional peripheral is not able to perform authentication due to network failure or the like, and the multi-functional peripheral performs authentication and output limitation, it is possible to manage the total number of output sheets of a user strictly and accurately.

1. A multi-functional peripheral of one or more multi-functional peripherals provided in a multi-functional peripheral control system, the multi-functional peripheral control system comprising an authentication server which has a user information management database for storing authentication information of each user and the number of outputtable sheets for each user, performs user authentication processing with reference to the user information management database, and manages the one or more multi-functional peripherals, the multi-functional peripheral comprising:
a storage portion that stores a user information management table that registers authentication information of each user and the number of outputtable sheets for each user;
a user confirmation portion that, when the authentication server is available, transmits user information to the authentication server so that the authentication server performs authentication processing using the user information, and, when the authentication server is not available, performs alternate authentication by referring to the user information management table;
a job execution portion that executes, when execution of a job in which the number of outputtable sheets is updated is instructed, the job in the case where the number of outputtable sheets concerning the job is not 0; and
a table updating portion that updates the user information management table based on data acquired from the user information management database of the authentication server when the authentication server is available and the user information is transmitted by the user confirmation portion and a job is executed by the job execution portion, and updates the user information management table by deducting the number of output sheets output by the job from the number of outputtable sheets that is registered in the user information management table when the authentication server is not available and the alternate authentication is performed by the user confirmation portion and the job is executed by the job execution portion.

2. The multi-functional peripheral as defined in claim 1, wherein
the job execution portion, when the authentication server becomes available, transmits to the authentication server the number of outputtable sheets registered in the user information management table updated by the table updating portion to update the number of outputtable sheets stored by the user information management database of the authentication server.

3. A multi-functional peripheral control system comprising an authentication server that has a user information management database for storing authentication information of each user and the number of outputtable sheets for each user and performs user authentication processing with reference to the user information management database, and one or more multi-functional peripherals managed by the authentication server, wherein
the multi-functional peripheral comprises:
a storage portion that stores a user information management table that registers authentication information of each user and the number of outputtable sheets for each user;
a user confirmation portion that, when the authentication server is available, transmits user information to the authentication server so that the authentication server performs authentication processing using the user information, and, when the authentication server is not available, performs alternate authentication by referring to the user information management table;
a job execution portion that executes, when execution of a job in which the number of outputtable sheets is updated is instructed, the job in the case where the number of outputtable sheets concerning the job is not 0; and
a table updating portion that updates the user information management table based on data acquired from the user information management database of the authentication server when the authentication server is available and the user information is transmitted by the user confirmation portion and a job is executed by the job execution portion, and updates the user information management table by deducting the number of output sheets output by the job from the number of outputtable sheets that is registered in the user information management table when the authentication server is not available and the alternate authentication is performed by the user confirmation portion and the job is executed by the job execution portion.

4. The multi-functional peripheral control system as defined in claim 3, wherein
the job execution portion of the multi-functional peripheral, when the authentication server becomes available, transmits to the authentication server the number of outputtable sheets registered in the user information management table updated by the table updating portion, and
the authentication server comprises an authentication portion that receives the number of outputtable sheets registered in the user information management table that is transmitted from the job execution portion to update the number of outputtable sheets stored in the user information management database of the authentication server to correspond to the number of outputtable sheets registered in the user information management table.
